(19) United States
(12) Patent Application Publication
(10) Pub. No.: US 2013/0147852 A1
(43) Pub. Date: Jun. 13, 2013

(54) Three-Dimensional Image Display Device

(71) Applicants: Pei-Lin Hsieh, Taoyuan County (TW); Chien-Hung Chen, New Taipei City (TW); Tzu-Chiang Shen, Taoyuan County (TW); Hsiang-Tan Lin, Keelung City (TW); Meng-Chao Kao, Taipei City (TW)

(72) Inventors: Pei-Lin Hsieh, Taoyuan County (TW); Chien-Hung Chen, New Taipei City (TW); Tzu-Chiang Shen, Taoyuan County (TW); Hsiang-Tan Lin, Keelung City (TW); Meng-Chao Kao, Taipei City (TW)

(73) Assignee: CHUNGHWA PICTURE TUBES, LTD., Bade City (TW)

(21) Appl. No.: 13/423,435

(22) Filed: Mar. 19, 2012

(30) Foreign Application Priority Data
Dec. 7, 2011 (TW) 100145066

(51) Int. Cl. G09G 5/10

(52) U.S. Cl. 345/690

(57) ABSTRACT

A three-dimensional image display device is provided. The three-dimensional image display device includes a display panel and a plurality of light control units. The display panel includes a pixel array composed of a plurality of pixels. Each of the pixels consists of a plurality of sub-pixels. The sub-pixel has an aspect ratio of about 1:1. A symmetry axis of each of the light control units is substantially parallel to a diagonal of each of the sub-pixels.

### RELATED APPLICATIONS

This application claims priority to Taiwan Application Serial Number 100145066, filed Dec. 7, 2011, which is herein incorporated by reference.

### BACKGROUND

1. Technical Field

The present invention relates to a three-dimensional image display device.

2. Description of Related Art

In recent years, the display technology has been developed toward a three-dimensional display technology. The three-dimensional display technology is realized by using parallax of human eyes to provide two different images to two eyes, thereby generating three-dimensional feeling. Three-dimensional display techniques are primarily classified into two categories: viewing with glasses (glasses type) and viewing with naked eyes (auto-stereoscopic type). However, the auto-stereoscopic type has become mainstream recently due to inconvenience of wearing glasses.

The auto-stereoscopic technology may be achieved by projecting a left eye image and a right eye image to a left eye and a right eye respectively through parallax barriers or lenses for generating a three-dimensional image. Recently, a three-dimensional display technique has been applied to a portable device such as a cell phone or a tablet PC, etc., which may be viewed in a landscape mode or a portrait mode according to a user's selection. In order to enable three-dimensional displaying performance in those two modes, the parallax barriers or lenses has to be tilt disposed relative to a pixel array. However, conventional three-dimensional display devices fail to exhibit good three-dimensional displaying effects in both the landscape mode and the portrait mode.

Therefore, a novel three-dimensional display device is needed to solve the problems mentioned above.

### SUMMARY

An aspect of the present invention is to provide a three-dimensional image display device. The device includes a display panel and a plurality of light control units. The display panel includes a pixel array composed of a plurality of pixels. Each of the pixels has a plurality of sub-pixels. Each of the sub-pixels has an aspect ratio of about 1:1. The sub-pixels constitute a plurality of sub-pixel groups for displaying a plurality of image information groups. The light control units are employed for converting the image information groups to a plurality of view angle images. A symmetry axis of each of the light control units is substantially parallel to one of the diagonals of each of the sub-pixels.

In one embodiment, the sub-pixels constitute a plurality of rows of the sub-pixels and a plurality of columns of the sub-pixels, and an included angle between the symmetry axis of each of the light control units and an extending direction of each of the rows of the sub-pixels or an extending direction of each of the columns of the sub-pixels is about 45°.

In one embodiment, each of the sub-pixel groups has a portion of the sub-pixels which are arranged along a diagonal of each of the portion of sub-pixels

In one embodiment, each of the pixels includes four sub-pixels which constitute an odd number of the sub-pixel groups to display an odd number of the image information groups.

In one embodiment, each of the pixels includes a red sub-pixel, a green sub-pixel and a blue sub-pixel.

In one embodiment, each of the pixels further includes a fourth sub-pixel.

In one embodiment, the fourth sub-pixel is a red sub-pixel, a green sub-pixel, a blue sub-pixel, a white sub-pixel, a cyan sub-pixel, a magenta sub-pixel or a yellow sub-pixel.

In one embodiment, each of the pixels includes three sub-pixels which constitute the sub-pixel groups to display the image information groups.

In one embodiment, each of the light control units is a lens.

In one embodiment, each of the light control units is a parallax barrier.

Since the sub-pixel is a square and each of the light control units is substantially parallel to one of the diagonals of any one sub-pixel, the three-dimensional image display device shows excellent three-dimensional image displaying performance in both landscape mode and portrait mode.

### BRIEF DESCRIPTION OF THE DRAWINGS

The invention may be more fully understood by reading the following detailed description of the embodiment, with reference made to the accompanying drawings as follows:

FIG. 1A and FIG. 1B are schematic diagrams of a three-dimensional image display device according to one embodiment of the present invention;

FIG. 2A to FIG. 2G are schematic diagrams showing pixels and sub-pixels according to embodiments of the present invention;

FIG. 3A to FIG. 3B are schematic diagrams showing a pixel array and a plurality of light control units according to one embodiment of the present invention; and

FIG. 4 is a schematic diagram showing pixels and axes of light control units according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

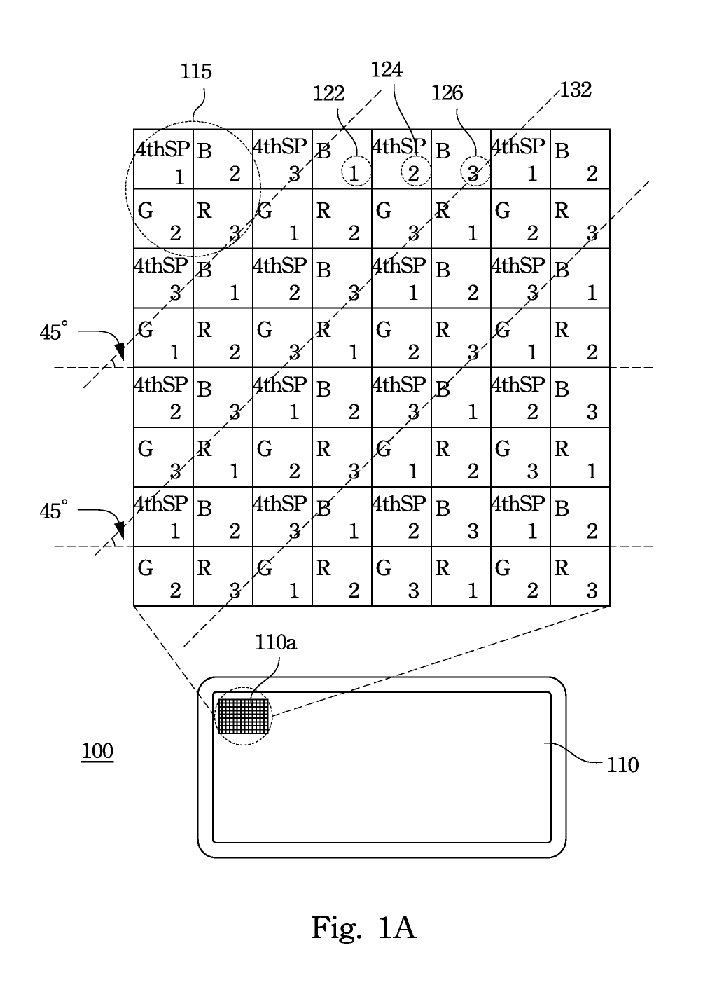

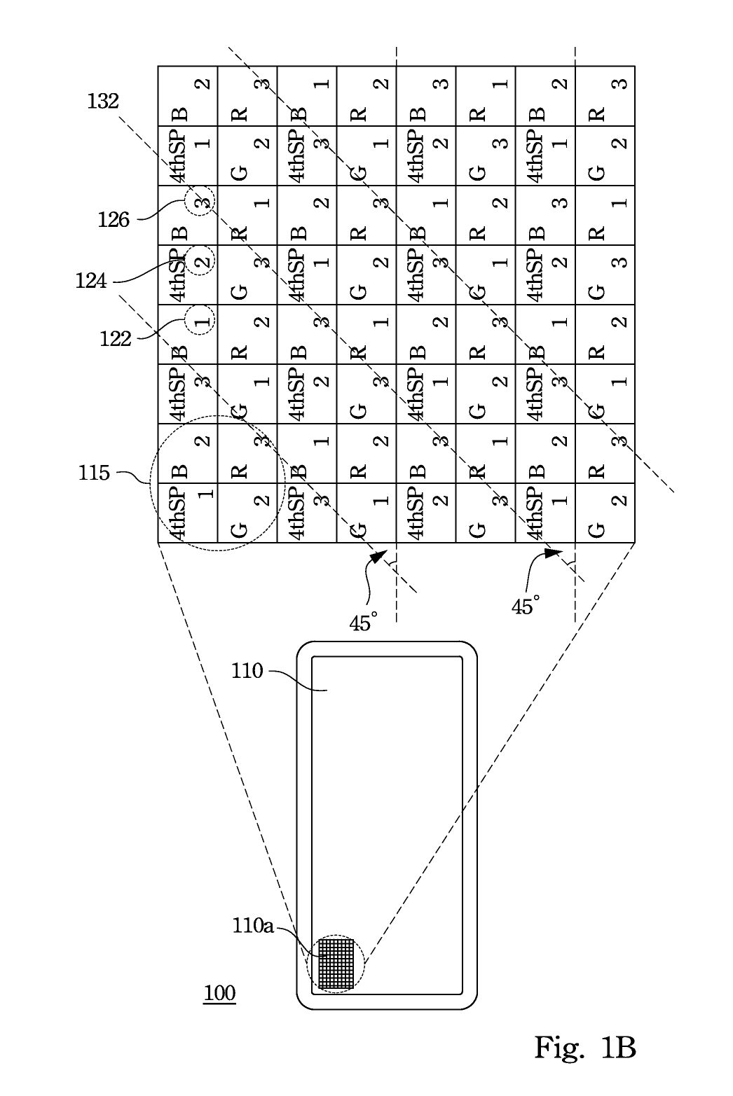

FIG. 1A to FIG. 1B are schematic diagrams of a three-dimensional image display device according to one embodiment of the present invention. One mode depicted in FIG. 1A is a landscape mode, and another mode depicted in FIG. 1B is a portrait mode.

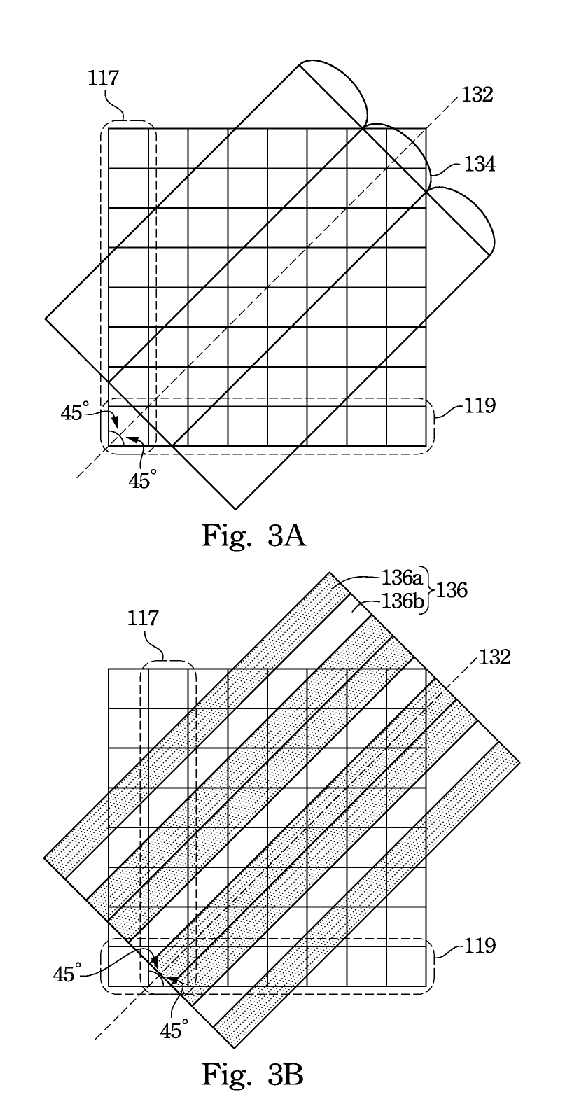

As depicted in FIG. 1A, a three-dimensional image display device 100 includes a display panel 110 and a plurality of light control units. For instance, the light control units may be lenses 134 in FIG. 3A or parallax barriesr 136 in FIG. 3B. The display panel 110 includes a pixel array 110a composed of a plurality of pixels 115. In one embodiment, each of the pixels 115 consists of four sub-pixels. The sub-pixels constitute an odd number of sub-pixel groups to show an odd number of image information groups. Each of the sub-pixels may be a square with an aspect ratio of approximately 1:1. For example, the aspect ratio may be about 1:1, 1:1.01 or 1:1.02.

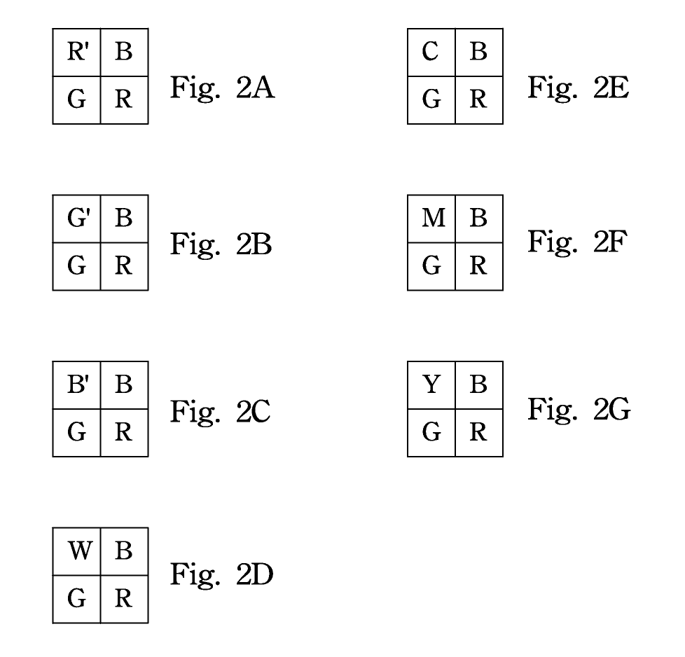

Each of the pixels may be composed of a red sub-pixel (R), a green sub-pixel (G), a blue sub-pixel (B), and a fourth sub-pixel (4thSP). FIG. 2A to FIG. 2G shows that the pixels are squares. The 4thSP may be a red sub-pixel (R′), a green sub-pixel (G′), a blue sub-pixel (B′), a white sub-pixel (W), a cyan sub-pixel (C), a magenta sub-pixel (M) or a yellow sub-pixel (Y). The sub-pixels R′, G′ and B′ may have the same or almost the same color as the sub-pixels R, to G and B respectively.

The sub-pixels may form an odd number of sub-pixel groups to display an odd number of image information groups. The term “odd number” herein refers to 3, 5, 7 or more. The image information groups may be converted to view angle images through the light control units. In other words, the sub-pixels in the same sub-pixel group are employed to display one of the desired view angle images.

As depicted in FIG. 1A, the sub-pixels construct three sub-pixel groups, which are a first sub-pixel group 122, a second sub-pixel group 124 and a third sub-pixel group 126. The first sub-pixel group 122 includes the sub-pixels labeled with 4thSP₁, B₁, G₁ and R₁. The second sub-pixel group 124 includes the sub-pixels labeled with 4thSP₂, B₂, G₂ and R₂. The third sub-pixel group 126 includes the sub-pixels labeled with 4thSP₃, B₃, G₃ and R₃.

A configuration of the sub-pixel groups is exemplified in the below. The pixel array may be regarded as a plurality of columns constructed by the sub-pixels from top to bottom. The first column of sub-pixels are arranged and repeated in an order of 4thSP₁, B₂, 4thSP₃, B₁, 4thSP₂ and B₃ from left to right. The second column of sub-pixels are arranged and repeated in an order of G₂, R₃, G₁, R₂, G₃ and R₁. The third column of sub-pixels are arranged and repeated in an order of 4thSP₃, B₁, 4thSP₂, B₃, 4thSP₁ and B₂ from left to right. The fourth column of sub-pixels are arranged and repeated in an order of G₁, R₂, G₃, R₁, G₂ and R₃ from left to right. The fifth column of sub-pixels are arranged and repeated in an order of 4thSP₂, B₃, 4thSP₁, B₂, 4thSP₃ and B₁ from left to right. The sixth column of sub-pixels are arranged and repeated in an order of G₃, R₁, G₂, R₃, G₁ and R₂ from left to right. Similarly, the sub-pixels of following columns are arranged and repeated in the orders as described above.

In one embodiment, each of the sub-pixel groups has a portion of the sub-pixels arranged along a diagonal of each sub-pixel in the portion of the sub-pixels. In other words, the sub-pixels along the diagonal of each of the sub-pixels belong to the same sub-pixel group. The first sub-pixel group 122 includes one subgroup consisting of B₁ and G₁ and another subgroup consisting of 4thSP₁ and R₁, as depicted in FIG. 1A. The second sub-pixel group 124 includes one subgroup consisting of B₂ and G₂ and another subgroup consisting of 4thSP₂ and R₂. The third sub-pixel group 126 includes one subgroup consisting of B₃ and G₃ and another subgroup consisting of 4thSP₃ and R₃. The sub-pixels in the same subgroup mentioned above are all arranged along one of the diagonal directions. As mentioned above, each of the sub-pixel groups includes the red sub-pixels R, the green sub-pixels G, the blue sub-pixels B and the fourth sub-pixels 4^{th}SP for thereby displaying a full-color image information group. For example, an image provided by the first sub-pixel group 122, which includes both the subgroup consisting of B₁ and G₁ and the other subgroup consisting of 4thSP₁ and R₁, may be projected to one eye of a viewer through the light control units. Also, another image provided by the second sub-pixel group 124, which includes both the subgroup consisting of B₂ and G₂ and the other subgroup consisting of 4thSP₂ and R₂, may be projected to the other eye of the viewer through those units.

Afterwards, the image information groups shown by the first sub-pixel group 122, the second sub-pixel group 124 and the third sub-pixel group 126 may be respectively converted to a first view angle image, a second view angle image and a third view angle image through the light control units. While the left eye and the right eye of a viewer see the first and the second view angle images respectively or see the second and the third view angle images respectively, a three-dimensional image is formed.

If the sub-pixels in the pixel array construct an even number of sub-pixel groups, each of the sub-pixel groups merely includes two of the red-sub-pixel, the green sub-pixel, the blue sub-pixel and the fourth sub-pixel. For instance, the first column of sub-pixels are arranged and repeated in an order of 4thSP₁, B₂, 4thSP₁, B2, 4thSP₁, B2, 4thSP₁ and B₂. The second column of sub-pixels are arranged and repeated in an order of G₂, R₁, G₂, R₁, G₂, R₁, G₂ and R₁. Also, the sub-pixels of following columns are arranged and repeated in the orders mentioned above. One certain sub-pixel group formed merely includes the fourth sub-pixel and the red sub-pixel. The other sub-pixel group merely includes the blue sub-pixel and the green sub-pixel. Consequently, such a display device can only generate a view angle image with partial colors. The sub-pixels depicted in FIG. 1A should construct an odd number of the sub-pixel groups due to the reason mentioned above.

FIG. 3A to FIG. 3B are schematic diagrams showing a pixel array 110a and a plurality of light control units according to one embodiment of the present invention. For instance, the light control units may be lenses 134 depicted in FIG. 3A or parallax barrier 136 depicted in FIG. 3B. A symmetry axis 132 of each of the light control units is substantially parallel to one of the diagonals of each of the sub-pixels. Each of the light control units has a width and a length. The term “symmetry axis” herein is defined as a central axis line along a length direction of a light control unit. In other words, the symmetry axis is parallel to one of the longer sides of the light control unit.

In another aspect, the sub-pixels may construct a plurality of sub-pixel rows 117 and a plurality of sub-pixel columns 119. An included angle between a symmetry axis of each of the light control units and an extending direction of each of the sub-pixel rows 117 or an extending direction of each of the sub-pixel column 119 is approximately 45°. Specifically, an included angle between a vertical projection of the symmetry axis of the light control unit on a pixel array 110a and the extending direction of each of the sub-pixel row 117 or the sub-pixel column 119 is about 45°. For instance, the included angle may be 43°, 44°, 45°, 46° or 47°.

In one embodiment, the light control units may be lenses 134, as depicted in FIG. 3A. In one example, the lenses 134 are lenticular lenses substantially parallel-disposed over the pixel array 110a. The symmetry axis 132 is the central axis line of the lens 134 and is parallel to one of the longer sides of that lens 134. Lenses 134 are employed to change light direction. Therefore, the lenses 134 may refract the image information groups displayed by the sub-pixel groups for generating the view angle images.

In another embodiment, the light control units may be a plurality of parallax barriers 136, as depicted in FIG. 3B. The parallax barriers 136 are disposed over the pixel array 110a. The parallax barrier 136 includes a shield region 136a and a light transmission region 136b. Since the light transmission region 136b may be a slit, the symmetry axis 132 may be defined as a central axis line of the shield region 136a. In other words, the symmetry axis 132 is parallel to one of the longer side of the shield region 136a. A portion of the image information groups is blocked by the shield region 136a, and thus cannot pass through the light transmission region 136b. The light transmission region 136b allows another portion of the image information groups to pass though, thereby generating the view angle images.

Since the sub-pixels are squares and the light control units are substantially parallel to one of the diagonals of each of the sub-pixels, the three-dimensional image display device 100 exhibit excellent three-dimensional image displaying effects in both the landscape mode and the portrait mode. As depicted in FIG. 1A, the light control units are tilted relative to the pixel array at about 45° in the landscape mode. Eyes of a viewer are easy to see different view angle images. Also, the light control units are tilted relative to the pixel array at about 45° in the portrait mode as depicted in FIG. 1B. Consequently, the problem of poorer three-dimensional image displaying effect in a certain viewing mode will not occur.

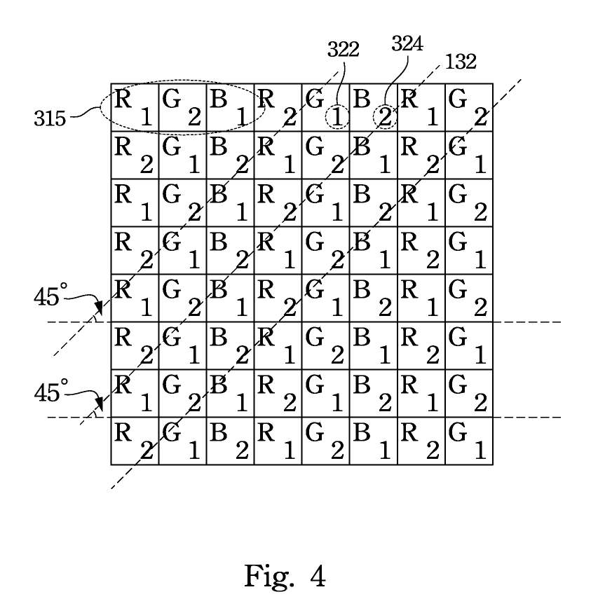

FIG. 4 is a schematic diagram showing pixels and axes of light control units according to another embodiment of the present invention. In one embodiment, each of the pixels 315 is composed of three sub-pixels, which are a red sub-pixel R, a green sub-pixel G and a blue sub-pixel B for displaying red, green and blue colors respectively. Each of the sub-pixels may be a square with an aspect ratio of about 1:1.

The sub-pixels described above may construct two or more sub-pixel groups for displaying two or more image information groups. For example, the sub-pixels construct two sub-pixel groups, which are a first sub-pixel group 322 and a second sub-pixel group 324 shown in FIG. 4. A configuration of the sub-pixels and sub-pixel groups is exemplified below. The pixel array may be considered as a plurality of columns composed of the sub-pixels from top to bottom. The first column of sub-pixels are arranged and repeated in an order of R₁, G₂, B₁, R₂, G₁ and B₂ left to right. The second column of sub-pixels are arranged and repeated in an order of R₂, G₁, B₂, R₁, G₂ and B₁ from left to right. The sub-pixels of following columns are arranged and repeated in the orders described above.

In one embodiment, each of the sub-pixel groups has a portion of the sub-pixels arranged along a diagonal of each sub-pixel in the portion of the sub-pixels. In other words, the sub-pixels along the diagonal of each of the sub-pixels belong to the same sub-pixel group. The first sub-pixel group 322 includes a subgroup consisting of R₁, G₁, and B₁, as depicted in FIG. 4. The second sub-pixel group 324 includes a subgroup consisting of R₂, G₂, and B₂. As mentioned above, each of the sub-pixel groups includes the red sub-pixels R, the green sub-pixels G and the blue sub-pixels B for thereby displaying a full-color image information group.

A symmetry axis of each of the light control units is substantially parallel to one of the diagonals of each of the sub-pixels, as depicted in FIG. 4. Thus, regardless of being in the landscape mode or the portrait mode, the display device still exhibits good three-dimensional image displaying effects.

FIG. 1A to FIG. 1B and FIG. 4 exemplify two arrangements of sub-pixels and sub-pixel groups. FIG. 1A to FIG. 1B illustrates a pixel array consisting of the red sub-pixel R, the green sub-pixel G, the blue sub-pixel B and the fourth sub-pixel 4thSP with an odd number of the sub-pixel groups. FIG. 4 shows a RGB pixel array with a plurality of the sub-pixel groups. Consequently, a suitable number of sub-pixel groups and a configuration thereof may be determined according to the amounts of sub-pixel types and display colors thereof.

As mentioned above, the light control units are substantially parallel to one of the diagonals of each of the square sub-pixels such that the three-dimensional image display device shows excellent three-dimensional image displaying effects in both the landscape mode and the portrait mode. In addition, the aforementioned structures may be also applied in other three-dimensional display techniques.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims.

What is claimed is:

1. A three-dimensional image display device, comprising:
a display panel including a pixel array, wherein the pixel array comprises a plurality of sub-pixels, each of the sub-pixels having an aspect ratio of 1:1 substantially, and the sub-pixels construct a plurality of sub-pixel groups to display a plurality of image information groups; and
a plurality of light control units for converting the image information groups to a plurality of view angle images, wherein a symmetry axis of each of the light control units is substantially parallel to a diagonal of each of the sub-pixels.

2. The device of claim 1, wherein the sub-pixels construct a plurality of rows of the sub-pixels and a plurality of columns of the sub-pixels, and an included angle between the symmetry axis of each of the light control units and an extending direction of each of the rows of the sub-pixels or an extending direction of each of the columns of the sub-pixels is about 45°.

3. The device of claim 1, wherein each of the sub-pixel groups has a portion of the sub-pixels which are arranged along a diagonal of each of the portion of sub-pixels.

4. The device of claim 1, wherein each of the pixels comprises four sub-pixels which construct an odd number of the sub-pixel groups to display an odd number of the image information groups.

5. The device of claim 1, wherein each of the pixels comprises a red sub-pixel, a green sub-pixel and a blue sub-pixel.

6. The device of claim 5, wherein each of the pixels further comprises a fourth sub-pixel.

7. The device of claim 6, wherein the fourth sub-pixel is a red sub-pixel, a green sub-pixel, a blue sub-pixel, a white sub-pixel, a cyan sub-pixel, a magenta sub-pixel or a yellow sub-pixel.

8. The device of claim 1, wherein each of the pixels comprises three sub-pixels which construct the sub-pixel groups for displaying the image information groups.

9. The device of claim 1, wherein each of the light control units is a lens.

10. The device of claim 1, wherein each of the light control units is a parallax barrier.
